(19) United States
(12) Patent Application Publication
(10) Pub. No.: US 2005/0110701 A1
(43) Pub. Date: May 26, 2005

(54) Retaining device for a vehicle radar sensor

(76) Inventor: Shih-Hsiung Li, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/721,861

(22) Filed: Nov. 26, 2003

(51) Int. Cl. H01Q 1/42

(52) U.S. Cl. 343/872

(57) ABSTRACT

A retaining device for a vehicle radar sensor has a housing and fastener. The housing has a chamber to retain the vehicle radar sensor therein. The fastener has a first engagement member to secure with the housing and a second engagement member that allows the retaining device to be attached to one edge of a rear cover of the vehicle without needing to drill a hole in the rear bumper.

### BACKGROUND OF THE INVENTION

1. Field of the Invention

The present invention relates to a retaining device for a vehicle reversing sensor, and more particularly to a retaining device that can be directly mounted on the vehicle without any destructive installment.

2. Description of Related Art

As well known in the art, a vehicle reversing system is composed of two main parts, a radar sensor mounted on the rear portion of the vehicle and a controller connected to the radar sensor. Since the controller is usually fitted in the interior of the car and not exposed, only the ordered lines layout for the controller is required.

On the other hand, the installation operation of the radar sensor is implemented by placing the radar sensor into a drilled hole in the rear bumper. Such a drilling operation may cause damage to the appearance of the vehicle if the workman lacks sufficient skill.

Therefore, there is a desire to have a superior solution to mount the radar sensor on the vehicle to obviate the aforementioned drawback.

### SUMMARY OF THE INVENTION

The main objective of the present invention is to provide a retaining device that allows the radar sensor to be installed in the vehicle without any destructive installation operation to prevent any possible damage to the vehicle appearance.

Other objects, advantages and novel features of the invention will become more apparent from the following detailed description when taken in conjunction with the accompanying drawings.

### BRIEF DESCRIPTION OF THE DRAWINGS

FIG. 1 is an exploded perspective view of a retaining device in accordance with the present invention;

FIG. 2 is a perspective view of the assembled retaining device of FIG. 1;

FIG. 3 is a cross-sectional view in partial showing the assembled retaining device of FIG. 1;

FIG. 4 is an operational plan view showing two retaining devices of the present invention are mounted on a rear cover of the vehicle;

FIG. 5 is a schematic view showing the retaining device of FIG. 1 is mounted on the rear cover;

FIG. 6 a schematic view showing a second embodiment of the retaining device is mounted on the rear cover in company with a screw; and

FIG. 7 is a schematic view showing the retaining device of FIG. 1 is mounted on the rear cover.

### DETAILED DESCRIPTION OF THE PREFERRED EMBODIMENT

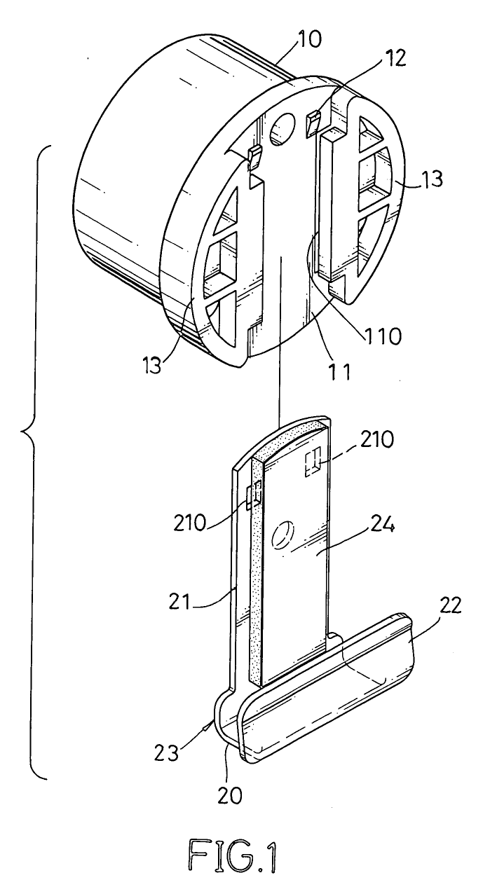

With reference to FIG. 1, a first embodiment of a retaining device for a vehicle reversing radar sensor is composed of a housing (10) and a fastener (20). The housing (10) having a chamber defined therein to receive a radar sensor (not shown), has a rear surface on which two substantially semicircular platforms (13) are oppositely formed to define a narrow path (11) between the two platforms (13). Two slots (110), parallel to the narrow path (11), are defined into the opposite sidewalls of the two platforms (13). Two blocks (12) that protrude from the rear surface of the housing (10) are formed near one end of the narrow path (11). Each block (12) is formed to have a slope.

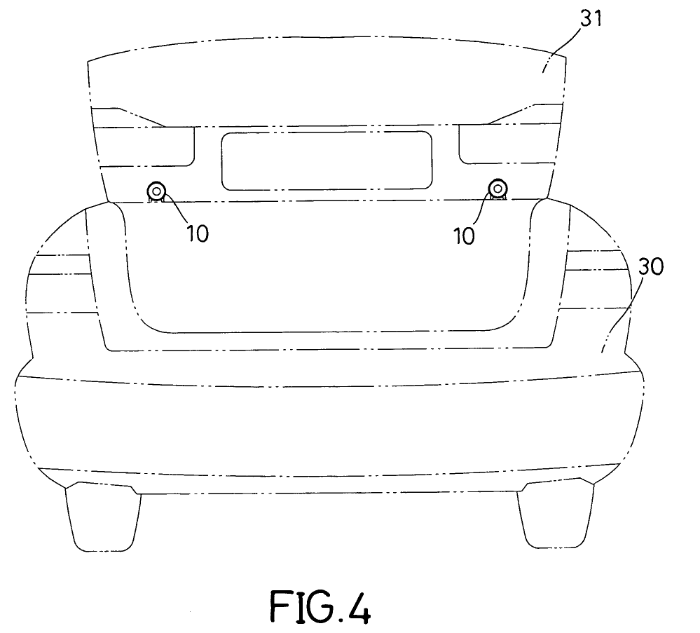

The fastener (20) includes a first engagement member and a second engagement member. The first engagement member is applied to achieve a connection with the narrow path (11) thereby assembling the fastener (20) to the housing (10). The second engagement member is used for clamping the fastener (20) to an edge of a rear cover of the vehicle (as shown in FIG. 4).

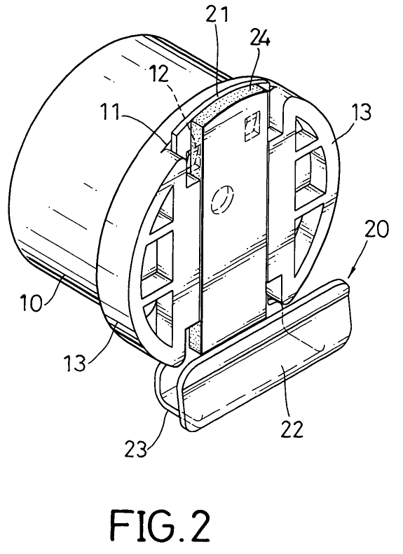

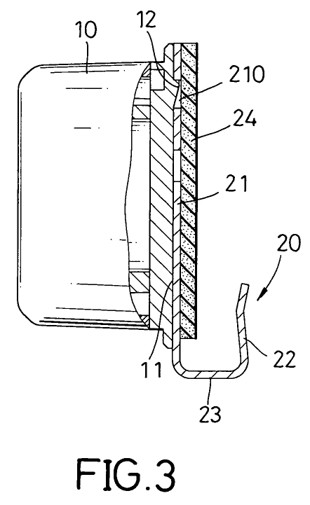

As shown in FIGS. 2 and 3, the fastener (20) has a clamping base (23) with a U-shaped cross-section. The clamping base (23) is formed by a bottom plate with two opposite edges from which a front plate (22) and a rear plate (21) integrally and perpendicularly extend. The front plate (22) is shorter than the rear plate (21) in the length but is wider than the rear plate (21) in the width. Furthermore, the distance between the front plate (22) and the rear plate (21) depends on the thickness of the rear cover of the vehicle.

Two through holes (210) are defined near one end of the rear plate (21) to correspond to the two blocks (12) of the housing (10). When the rear plate (21) slides along the path (11), two opposite edges of the rear plate (21) are tightly abutted against the sidewalls of the two slots (110). Further, the two blocks (12) are securely retained in the two through holes (210).

An auxiliary element is further attached to a first surface of the rear plate (21). The auxiliary element could be an adhesive strip (24) to enhance the connection between the fastener (20) and the surface of the rear cover. Another alternate embodiment of the auxiliary element is a magnet by which the fastener (20) is attached to the rear cover by magnetic force.

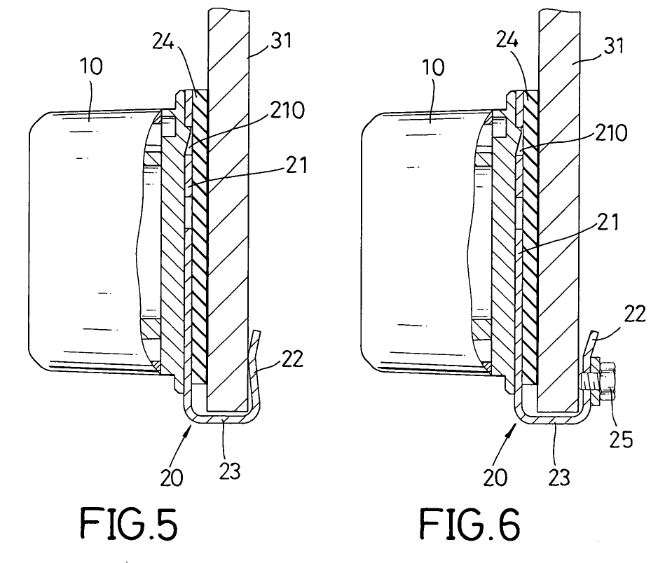

With reference to FIGS. 4 to 7, to install the retaining device in company with the radar sensor to the vehicle (30), the rear cover (31) is firstly raised so that the lower edge of the rear cover (31) can be securely clamped by the base (23) between the front plate (22) and the rear plate (21). Because the fastener (20) is made of thin metal plate, the front plate (22) functions as a resilient clamp to tightly abut against the surface of rear cover. In FIG. 6, the front plate (22) is further defined with a hole, whereby a screw (25) can insert through the hole to press against the surface rear cover (31) to enhance the engagement force.

Based on the foregoing discussion, the first engagement member of the fastener (20) includes the rear plate (21) together with the through holes (210) to perform the connection to the housing (10). In another aspect, the second engagement member includes the front plate (22) and the U-shaped base (23) for attaching to the vehicle (30).

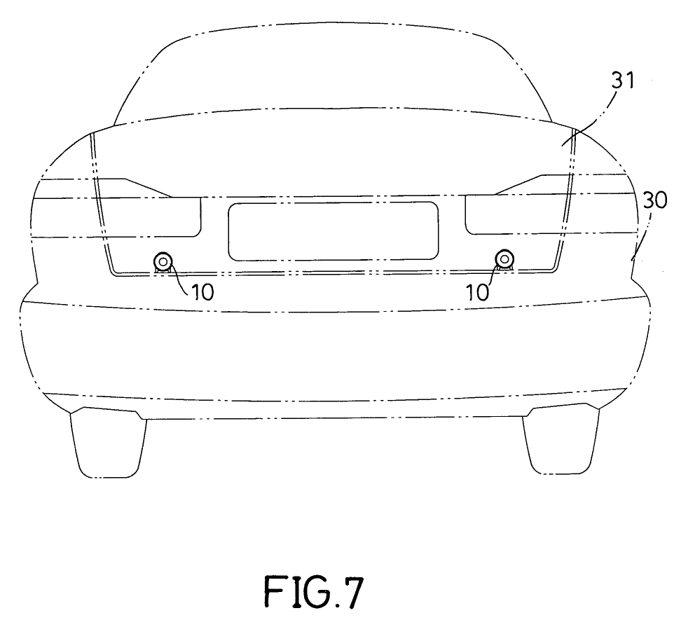

With reference to FIG. 7, when the rear cover (31) is pushed downwardly and closed, the open/close action of the rear cover (31) is not obstructed even when the retaining device is attached. The radar sensor secured by the retaining device is exposed to aim from the rear area of the vehicle (30) to transmit/receive detecting signals.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A retaining device for a vehicle radar sensor, the retaining device comprising:
a housing (10) defined with a chamber for retaining the vehicle radar sensor therein, wherein the housing (10) has a rear surface from which two opposite platforms (13) protrude to define a path (11) between the two platforms (13); and
a fastener (20) having a first engagement member and a second engagement member, wherein the first engagement member attaches to the path (11) of the housing, and the second engagement member is adapted to clamp an edge of a rear cover (31) of a vehicle (30) to allow the radar sensor to be exposed to face a rear area behind the vehicle (30).

2. The retaining device as claimed in claim 1, wherein two slots (110) parallel to the path (11) are defined into opposite sidewalls of the two platforms (13);
wherein the fastener (20) is formed by a clamping base (23) having two opposite edges from which a front plate (22) and a rear plate (21) integrally and perpendicularly extend, wherein when the rear plate (21) slides along the path (11), two opposite edges of the rear plate (21) are tightly abutted against the sidewalls of the two slots (110).

3. The retaining device as claimed in claim 2, wherein two blocks (12) are formed on the rear surface of the housing near one end of the path (11) to engage with two through holes (210) defined in the rear plate (21) of the fastener (20).

4. The retaining device as claimed in claim 2, wherein the clamping base (23) in company with the front plate (22) and the rear plate (21) is formed to have a U-shaped cross section, where the rear cover (31) of the vehicle is securely clamped between the front plate (22) and the rear plate (21).

5. The retaining device as claimed in claim 4, wherein an adhesive element (24) is mounted on a surface of the rear plate (21) to adhere to the rear cover (31).

6. The retaining device as claimed in claim 4, wherein a magnet is mounted on a surface of the rear plate (21) to attract to the rear cover (31).

7. The retaining device as claimed in claim 4, wherein the front plate (22) is defined with a hole that allows a screw (25) to insert therethrough to press against the rear cover (31).

8. The retaining device as claimed in claim 4, wherein the front plate (22) is shorter than the rear plate (21) in the length but is wider than the rear plate (21) in the width.
